(19) United States
(12) Patent Application Publication
(10) Pub. No.: US 2018/0169907 A1
(43) Pub. Date: Jun. 21, 2018

(54) METHOD FOR PRODUCING OF STRUCTURES ON A SUBSTRATE SURFACE

(71) Applicant: EV Group E. Thallner GmbH, St. Florian am Inn (AT)

(72) Inventor: Jurgen Burggraf, Scharding (AT)

(73) Assignee: EV Group E. Thallner GmbH, St. Florian am Inn (AT)

(21) Appl. No.: 15/580,132

(22) PCT Filed: Jun. 25, 2015
(86) PCT No.: PCT/EP2015/064394

§ 371 Date: Dec. 6, 2017

(51) Int. Cl. B29C 39/02; B29C 33/00; B29C 33/38; B29C 59/02

(52) U.S. Cl. CPC B29C 39/026; B29C 33/0083; B29C 2059/023; B29C 59/022; B29C 33/38

(57) ABSTRACT

A method and mould for producing millimetre and/or micrometre and/or nanometre-size structures on a substrate surface of a substrate.

Structures on the micrometre or even nanometre scale are routinely generated in the semiconductor industry. The production of such structures takes place with the aid of one of the countless methods of lithography. Imprint lithography in particular has become well established in recent years. With the aid of imprint lithography, nanometre-size structures can be embossed with the aid of a stamp.

For this purpose, an embossing compound is deposited on a substrate. After the deposition, an alignment of the embossing stamp relative to the substrate takes place. The embossing stamp and the substrate then approach one another. The structures of the embossing stamp are formed in the embossing compound. Before the removal of the embossing stamp from the embossing compound, the latter is hardened. The hardening takes place thermally and/or by means of electromagnetic radiation.

In imprint lithography, there is the problem of the inherent generation of a residual layer, which has to be removed by further process steps, in particular by etching. The removal of the residual layer is associated with additional costs and in particular also influences the structure itself, which is etched away by the same amount as the residual layer. The at least partial etching-away of the substrate is therefore an automatic by-product of the etching of the residual layer.

A further method for depositing structures on the surface of a substrate is micro contact printing (μCP). The μCP method does in fact permit in principle the transfer of a transfer compound from the structures of a stamp onto a substrate surface, but the material transfer is bound up with many problems. Thus, the transfer compound, during the application on the stamp, has to exhibit good adhesion to the latter, but must for the most part lose it after contacting with the substrate surface, in order to be able to detach itself. The use of a substrate surface which has a very much higher adhesion property to the transfer compound than to the stamp surface is also conceivable. However, the substrates and therefore the substrate surfaces are not freely selectable, but are often predetermined by the process. This is also the case with the stamps, which have to be produced from certain materials.

The problem, therefore, is to specify a method and a mould, wherein structures can be generated on a substrate surface of a substrate in a cost-effective manner and in a way that does not harm the substrate. Moreover, the materials of the casting compound, the mould and/or the substrate should be as freely selectable as possible.

This problem is solved by the subject-matter of the coordinated claims. Advantageous developments of the invention are given in the sub-claims. All combinations of at least two features given in the description, the claims and/or the drawings also fall within the scope of the invention. In value ranges, values lying inside the stated limits are also deemed to be disclosed as limiting values and can be claimed in any combination.

According to the invention, therefore, a method for producing millimetre and/or micrometre and/or nanometre-size structures on the substrate surface of the substrate is in particular proposed, with the following sequence:
a) arrangement of the mould over the substrate surface,
b) alignment of the mould relative to the substrate surface,
c) contacting of a structured surface of the mould with the substrate surface,
d) introduction of a casting compound into a network of the mould for the distribution of the casting compound over the structured surface of the mould,
e) hardening of the casting compound and
f) removal of the mould from the casting compound.

According to the invention, therefore, a mould is in particular further proposed, comprising at least one inflow for a casting compound and at least one network connected to the at least one inflow for distributing the casting compound over the structured surface of the mould.

A network is understood to mean in particular an interconnected number of channels and/or hollow spaces.

The essence of the invention therefore consists in particular in the production of structures on a substrate surface by a casting process, in particular in the production of residual layer-free structures on the substrate surface.

The invention advantageously permits the production of residual layer-free millimetre and/or micrometre and/or nanometre-size structures on the substrate surface.

In particular, the idea underlying the invention is to first place the mould on the surface of the substrate and then to convey the casting compound into the network of the mould by capillary forces and/or vacuum and/or excess pressure, in order to coat the substrate surface, in particular free from a residual layer. Generally, excess pressure is understood to mean a pressure that is greater than the pressure in the network in which the embossing compound is to be propagated. In particular, excess pressure is understood to mean a pressure above atmospheric pressure, in particular above 1 bar.

The invention can be used in particular for the production of millimetre and/or micrometre and/or nanometre-size structures. In particular, the invention is suitable for carrying out
packing processes, in particular for the encapsulation of components,
lithographic processes, in particular microlithographic processes and/or nanolithographic processes.

The following components in particular can be produced with the invention:
microfluidic devices,
optics,
   a diffraction optics, in particular
      diffraction gratings
      diffraction lenses
   lenses, in particular
      Fresnel lenses
microelectromechanical systems (MEMs).

The invention thus relates in particular to the use of the method according to the invention and the mould according to the invention for packing, in particular for the encapsulation of components. The invention further relates in particular to the use of the method according to the invention and the mould according to the invention for structuring processes, in particular microstructuring processes and/or nanostructuring processes. The invention further relates in particular to the use of the method according to the invention and the mould according to the invention for the production of microfluidic devices, optics and/or microelectromechanical systems.

The invention further relates to a substrate, comprising millimetre and/or micrometre and/or nanometre-size structures on a substrate surface of the substrate, produced with the method according to the invention and the mould according to the invention.

The mould comprises at least one network, in particular comprising interconnecting channels. Such a network is also referred to in the subsequent text simply as an interconnecting network. It would also be conceivable for a plurality of interconnecting networks to be present in the mould, which however are not connected to one another. Each of the interconnected networks must then comprise at least one inflow. The mould according to the invention comprises in particular less than 20, preferably less than 10, still more preferably less than 5, most preferably less than 3, with utmost preference less than 2 interconnecting networks. The sake of simplicity, mention will be made of only a single interconnecting network in the rest of the publication.

The network is filled by the casting compound in the method according to the invention. The network can in general be arbitrarily designed, as long as it is constituted completely interconnecting, i.e. all its channels interconnect. Non-interconnecting regions cannot be filled by the casting compound in the method according to the invention. The embodiments and processes according to the invention thus differ from conventional imprint technologies, wherein an embossing stamp is pressed into a casting compound and the generation of non-interconnecting regions is thus also enabled. Non-interconnecting regions can thus only be generated by moulds with a plurality of networks.

The network should be fluid-dynamically optimised. Such an optimisation is preferably calculated by simulation software. Sharp edges should as far as possible be avoided in the network and replaced by rounded portions. The rounded portions have radii less than 1 mm, preferably less than 100 μm, still more preferably less than 10 μm, most preferably less than 1 μm, with utmost preference less than 100 nm. Since the fluid-dynamic properties primarily depend on the ratio between the radius of the rounded portion and the channel width, the preferred ratios are disclosed as follows. The ratio between the radius of the rounded portion and the channel width is greater than 0.01, preferably greater than 0.1, still more preferably greater than 1, most preferably greater than 10, with utmost preference greater than 20.

The mould comprises at least one inflow per network, via which the casting compound is introduced. A plurality of inflows is also conceivable, in particular more than one inflow, still more preferably more than 2 inflows, still more preferably more than 5 inflows, most preferably more than 10 inflows, with utmost preference more than 20 inflows per network. The casting compound can thus advantageously be distributed better in the network or in the networks.

The inflows can be arranged symmetrically or asymmetrically around the mould. The distribution of the inflows advantageously corresponds to the design of the network. In particular, the inflows are distributed such that more inflows are present in regions with a large volume to be filled. in the ideal case, the ratio of volume to the number of inflows is in particular constant. A more precise or more preferred description of the ratio between the number of inflows and the volume to be filled is provided by the mass flow. The mass flow is understood to mean the mass that is transported per unit of time through a cross-section. The ratio between the volume to be filled and the mass flow flowing into the volume is therefore preferably constant. If a plurality of inflows emerge into a volume, the mass flow is understood to mean the sum of all the mass flows per inflow.

In a preferred embodiment according to the invention, the inflows are arranged asymmetrically, in particular only on one side of the mould. As a result of the asymmetrical positioning of the inflows, the casting compound can be introduced a symmetrically and can flow out asymmetrically, in particular via one or more outflows on a side of the mould lying diametrically opposite the inflows.

In an alternative preferred embodiment according to the invention, the inflows are arranged symmetrically, in particular directed towards the centre of the mould. In the case of a symmetrical arrangement of the inflows, in particular directed towards the centre, the gases displaced by the casting compound can, as long as a vacuum is not created, escape via an, in particular, central outflow. This, in particular central, outflow preferably leaves the mould at the upper mould surface, in particular facing away from the structured surface of the mould.

In another preferred embodiment, the mould comprises an inflow and an outflow which are connected to one another via the network. The inflow and the outflow leave the mould for example via the upper mould surface. Alternatively, the inflow and the outflow leave the mould for example via the lateral mould face.

In another preferred embodiment, the mould comprises two symmetrically positioned inflows and an outflow, which are connected to one another via a network. The inflows leave the mould in particular via the lateral mould face and the outflow leaves the mould in particular via the mould surface.

Inflows and outflows can in particular be exchanged, so that it is possible to supply the casting compound via an outflow and to discharge it via an inflow.

In another preferred embodiment, the mould comprises an inflow and no outflow, but rather a porous material, so that gases can escape via the mould, or more precisely the pores of the mould.

The network comprises a plurality of channels, in particular branching channels. The channels can have any cross-section. The cross-section is however preferably rectangular, Triangular, trapezoidal, round cross-sections or a combination of these cross-sections would in particular also be conceivable. The channels of the network must be produced in the mould. It is easiest from the process standpoint to produce rectangular, trapezoidal or triangular depressions, in particular by etching processes and by using the crystallographic orientation of a monocrystalline substrate.

Rectangular cross-sections have a width which is less than 1 mm, preferably less than 100 μm, still more preferably less than 10 μm, most preferably less than 1 μm, with utmost preference less than 100 nm. Rectangular cross-sections have a depth which is less than 1 mm, preferably less than 100 μm, still more preferably less than 10 μm, most preferably less than 1 μm, with utmost preference less than 100 nm, Triangular cross-sections have a triangle height which is less than 1 mm, preferably less than 100 μm, still more preferably less than 10 μm, most preferably less than 1 μm, with utmost preference less than 100 nm. Triangular cross-sections have a triangle side length which is less than 1 mm, preferably less than 100 μm, still more preferably less than 10 μm, most preferably less than 1 μm, with utmost preference less than 100 nm.

Round cross-sections have a radius which is less than 10 mm, preferably less than 1 mm, still more preferably less than 100 μm, most preferably less than 10 μm, with utmost preference less than 1 μm.

Adaptors can be fitted to the at least one inflow and/or at least one outflow. The adapters are connection components, which permit a loss-free transfer and/or take-over of the casting compound into and/or out of the network. The adapters are therefore preferably provided with sealing elements.

If there is a plurality of outflows, the casting compound may become divided during the outflow and thus form bubbles. The number of outflows is therefore preferably minimal, since the bubble formation is thus reduced. The number of outflows is therefore less than 20, preferably less than 10, still more preferably less than 5, most preferably less than 2, with utmost preference precisely 1.

In particular embodiments according to the invention, the mould does not comprise any outlet, but is so porous that gas present can escape through the pores of the mould, whereas the molecules of the casting compound are too large to escape through the porous mould According to the invention, a still better distribution of the casting compound in the mould can in particular thus be achieved, since the pressure building up ensures a better, in particular more complete, and therefore bubble-free distribution of the casting compound.

The average pore size of the mould is less than 1 μm, preferably less than 100 nm, still more preferably less than 10 nm, most preferably less than 1 nm. The porosity is in particular an open porosity.

The porosity permits the escape of gases through the mould. The gases are either introduced into the mould or the network in particular during the casting process or arise during the hardening, in particular the exposure. In particular, outflows can thus be dispensed with.

The mould can be constituted as a hard or soft mould. The soft mould will be referred to as a soft stamp in the case of imprint technology.

A hard mould has a great elasticity. The elasticity is described by the modulus of elasticity. The modulus of elasticity of a hard mould is between 1 GPa and 1000 GPa, preferably between 10 GPa and 1000 GPa, more preferably between 25 GPa and 1000 GPa, with greatest preference between 50 GPa and 1000 GPa, with utmost preference between 100 GPa and 1000 GPa. The modulus of elasticity of several types of steel lies for example at around 200 GPa.

The hard mould is preferably made from one of the following materials or material classes:
metals, in particular
   Cu, Ag, Au, Al, Fe, Ni, Co, Pt, W, Cr, Pb, Ti, Ta, Zn, Sn
semiconductors, in particular
   Ge, Si, alpha-Sn, fullerene, B, Se, Te
compound semiconductors, in particular
   GaAs, GaN, InP, InxGal-xN, InSb, InAs, GaSb, AIN, InN, GaP, BeTe, ZnO, CuInGaSe2, ZnS, ZnSe, ZnTe, CdS, CdSe, CdTe, Hg(l-x)Cd(x)Te, BeSe, HgS, AlxGal-xAs, GaS, GaSe, GaTe, InS, InSe, InTe, CuInSe2, CuInS2, CuInGaS2, SiC, SiGe, Si
alloys, in particular
   metal alloys
ceramics, in particular
   clay ceramics
   functional ceramics
   Non-metallic glasses, in particular
      organic non-metallic glasses
      inorganic non-metallic glasses, in particular
non-oxidic glasses, in particular
   halide glasses
   chalcogenide glasses
oxidic glasses, in particular
   phosphatic glasses
   silicate glasses, in particular
      alumosilicate glasses
      lead silicate glasses
      alkali silicate glasses, in particular
alkaline earth silicate glasses
   borosilicate glasses
   borate glasses, in particular
   alkali borate glasses

A soft mould has a lower elasticity. The elasticity is described by the modulus of elasticity. The modulus of elasticity of a soft mould is between 1 GPa and 100 GPa, with greatest preference between 1 GPa and 50 GPa, with utmost preference between 1 GPa and 20 GPa.

The soft mould is preferably made from one of the following materials or material classes:
polymers, in particular
   thermoplastics
   thermosetting plastics
   a silicates, in particular
      tetraethyl orthosilicate (TEAS)
   siloxanes, in particular
      silesium quioxane
         polyhedral oligomeric silesium quioxane (MOSS)
      PDMS (polydimethyl siloxanes)
   fluoropolvmers, in particular
      perfluoropolyether (PFPE)

According to the invention, the mould comprises structures at its mould contact side (also referred to as a structured surface). The structures are in particular less than 1 mm, preferably less than 100 μm, still more preferably less than 10 μm, most preferably less than 100 nm, with utmost preference less than 10 nm.

The mould contact side (structured surface) can be coated or restacked. A coating preferably serves for an anti-adhesion effect between the structures and the substrate surface and/or an anti-adhesion effect between the structures and the casting compound. In the case of an anti-adhesion layer, the adhesive effect is preferably minimal. The adhesive effect is indicated by the energy that is required to separate two surfaces from one another again, in particular the substrate surface from the structured surface or the casting compound surface from the structured surface. The energy is indicated in J/m². The energy per unit area is less than 2.5 J/M², preferably less than 0.1 J/m², still more preferably less than 0.01 J/m², most preferably less than 0.001 J/m², with greatest preference less than 0.0001 J/m², with utmost preference less than 0.00001 J/m².

The anti-adhesion coating primarily ensures that the mould is separated from the substrate and/or the casting compound in the mould removal process with little expenditure of force. Functional coatings, in particular of metal, which can be charged electrically in order to generate a specific potential of the surface, would also be conceivable as an alternative.

The mould is preferably also used for the thermal and/or electromagnetic hardening of the casting compound.

If the mould is to be used for the thermal hardening of the casting compound, the thermal conductivity is preferably at a maximum. The thermal conductivity lies between 0.1 NAT/(m*K) and 5000 W/(m*K), preferably between 1 W/(m*K) and 2500 W/(m*K), still more preferably between 10 W/(m*K) and 1000 W/(m*K), most preferably between 100 W/(m*K) and 450 W/(m*K).

The heat quantity that is used for the hardening of the casting compound should not be stored in the mould, but should rather be transported to the casting compound. The thermal capacity of the mould should therefore be as small as possible. The thermal capacity of the mould according to the invention is as small as possible in order to prevent storage of heat. In the case of most solids, the thermal capacity at moderate temperatures and pressures differs only marginally with a constant volume from the thermal capacity at constant pressure. In the subsequent text of the publication, therefore, no distinction is made between the two thermal capacities.

Furthermore, specific thermal capacities are stated. The specific thermal capacity is less than 20 kJ/(kg*K), preferably less than 10 kJ(kg*K), still more preferably less than 1 kJ/(kg*K), most preferably less than 0.5 kJ/(kg*K), with utmost preference less than 0.1 kJ/(kg*K).

If the casting compound is hardened electromagnetically through the mould, the mould must be transparent for the electromagnetic radiation. The casting compound is transparent in particular for electromagnetic radiation in the wavelength range between 10 nm and 2000 nm, preferably between 10 nm and 1500 nm, more preferably between 10 nm and 1000 nm, most preferably between 10 nm and 500 nm, with utmost preference between 10 rim and 400 nm.

If the mould is constituted as a soft mould, fixing of the soft mould on a rigid substrate (backplane) is conceivable. The soft mould remains sufficiently elastic to be removed easily from the moulding compound, but it has sufficient strength due to the rigid substrate. In particular embodiments according to the invention, the rigid substrate is nonetheless sufficiently elastic to be easily bent. A particularly easy removal of the soft casting compound from the periphery thus becomes possible, in particular in a continuous and gradual process. The use of a rigid substrate, in particular with alignment marks, also facilitates the positioning and alignment of the soft mould with respect to the substrate on which the method according to the invention is to be carried out.

A further embodiment according to the invention relates to a mould, wherein a mask with apertures is arranged, in particular deposited, on the mould surface that lies opposite the structured surface of the mould. The mask permits masking of the exposure region. The electromagnetic radiation illuminates only the areas of the mould that lie directly beneath the apertures of the mask. Non-illuminated areas can simply be removed in subsequent process steps. According to the invention, it is thus made possible in a particularly straightforward manner to generate non-interconnecting regions. The casting compound is in fact distributed completely over the interconnecting network, but continues to be masked and therefore structured during the hardening process.

The mask is in particular opaque for the wavelengths of the wavelength region of the radiation with the aid of which the casting compound is hardened. By using a mask, those regions of the casting compound that are to be hardened can be precisely determined. In particular embodiments according to the invention, the apertures do not necessarily have to be congruent with the network. A finer structuring of the network is thus permitted, since those regions of the network that are not hardened by the electromagnetic radiation can be removed from the substrate surface in subsequent process steps. Masks, the apertures whereof are congruent with the network are of course also conceivable. The apertures are incorporated in the mould in a much preferred embodiment.

The apertures are areas kept free from opaque material layers deposited on the mould. The material of the material layer itself is non-transparent for the electromagnetic radiation used, with the aid of which the casting compound is to be hardened. The material surrounding the apertures is made in particular of metal.

For the sake of completeness, it is mentioned that the embodiments and processes according to the invention in principle permit the distribution and/or deposition of an arbitrary liquid. The embodiment according to the invention, therefore, is designed not only for the deposition of a casting compound in particular, but also for the deposition of a liquid in general. For example, the deposition according to the invention of an anti-adhesion liquid along the network or a network path would also be conceivable. In this case, it is also conceivable for the liquid to be partially removed again. A further conceivable option would be the deposition of a bonding agent, in particular before the introduction of the casting compound, in order to increase the adhesion between the casting compound and the substrate. In the subsequent text of the publication, however, only a casting compound which is to be deposited along the network path in order to generate hardened structures which perform a topographical task will be dealt with by way of example.

The casting compound should have as low a viscosity as possible, in order to enable to enable an optimum, efficient, rapid and, in particular, bubble-free filling of the network according to the invention. A viscosity is a physical property which is highly dependent on temperature. The viscosity generally diminishes with increasing temperature. At room temperature the viscosity lies between 10E6 mPa*s and 1 mPa*s, preferably between 10E5 mPa*s and 1 mPa*s, still more preferably between 10E4 mPa*s and 1 mPa*s, most preferably between 10E3 mPa*s and 1 mPa*s, In general, it is the case that the smaller the dimensions of the network, in particular the dimensions of the cross-sections of the channels, the lower must be the viscosity of the casting compound.

The adhesive effect between the casting compound and the mould should be as small as possible, in order to achieve an efficient removal of the mould from the casting compound. The adhesive effect is indicated by the energy that is required to separate the two surfaces from one another again. The energy is indicated in J/m². The energy per unit area is less than 2.5 J/m², preferably less than 0.5 J/m², still more preferably less than 0.3 J/m², most preferably less than 0.1 J/m², with greatest preference less than 0.01 J/m², with utmost preference less than 0.001 J/m².

The adhesive effect between the casting compound and the substrate should be as great as possible in order to prevent a destruction of the cast structures during the removal of the mould from the casting compound. The adhesive effect is indicated by the energy that is required to separate the two surfaces from one another again. The energy is indicated in J/m². The energy per unit area is greater than 0.00001 J/m², preferably greater than 0.0001 J/m², still more preferably greater than 0.001 J/m², most preferably greater than 0.01 J/m², with greatest preference greater than 0.1 J/m², with utmost preference greater than 1.0 J/m².

The casting compound can be hardened either thermally and/or electromagnetically, in particular by UV light.

According to the invention, a system or a stack comprises at least one substrate and one mould according to the invention. The mould is contacted with the substrate before the filling with the casting compound. The combination of substrate and mould is also referred to as a stack. The stack is in particular supported on a sample holder. The stack is fixed relative to the sample holder. The fixing can take place by means of clamps. The fixing preferably takes place by means of a pressure application unit lying opposite the sample holder, which unit exerts pressure on the stack. Fixing of the mould relative to the substrate, in particular by tacking, is also possible. Tacking is a fixing of two surfaces by means of heat acting in particular locally, especially by means of a laser. The laser acts, in particular locally, at at least 1 point, preferably at as least 2 points, still more preferably at at least 3 points, most preferably at at least 5 points, with utmost preference at approximately 10 points locally and thus fixes the mould on the substrate. The adhesive strength thus generated between the substrate and the mould is sufficiently great to prevent a displacement with respect to one another, but is sufficiently small such that they can easily be separated again after the casting process according to the invention.

The casting compound is preferably introduced directly via at least one inflow into the network of the mould. The connection between a supply and the inflow is in particular provided. The supply of the casting compound via a tube, a needle and/or a nozzle is conceivable. In particular, an adapter can be fitted between the tube, the needle or the nozzle and the mould in order to create an optimum form-fitting connection.

Unless stated otherwise, pressures always relate to the absolute pressure scale.

In a further embodiment according to the invention, the stack and/or the mould and/or the sample holder are located in a process chamber capable of being evacuated. The process is carried out in particular in a vacuum atmosphere with a pressure less than 1 bar, preferably less than 0.1 bar, more preferably less than 0.01 bar, still more preferably less than 1 mbar, most preferably less than 0.1 mbar. The network of the mould is evacuated via the process chamber. The casting compound is preferably introduced directly by means of a supply into the network.

The loading and arrangement of the, in particular transparent, mould over the substrate or the substrate surface takes place in a first process step according to the invention. The mould can be loaded over the substrate manually, semi-automatically and/or fully automatically. Robots are preferably used in the case of semi-automatic and/or fully automatic loading. The substrate can be fixed on a sample holder by fixings, in particular vacuum tracks.

The alignment of the mould relative to the substrate or relative to the substrate surface takes place in a second process step according to the invention. The alignment takes place in particular mechanically and/or optically. The alignment can take place in particular in the x- and/or y-direction. In particular, a particularly accurate alignment of the mould can take place with the aid of alignment marks. The mould is preferably still located on a robot. Fixing of the mould by means of a robot on a second, upper sample holder, which has a better resolution accuracy, is also conceivable. In particular, the loading and alignment of the mould in an alignment system is conceivable, in order to carry out the alignment with a high degree of precision.

The contacting of the mould or the structured surface of the mould with the substrate or with the substrate surface takes place in the third process step according to the invention. The contacting takes place in particular in an approach process, wherein a relative approach between the mould and the substrate takes place. The mould and the substrate preferably make contact with one another with a very small contact pressure, in particular brought about solely by the weight force. The structured surface can in particular be coated, in order to facilitate a mould removal in a subsequent process step. In particular, a completed, interconnecting network open to the atmosphere arises as a result of the contacting of the structured surface with the substrate surface. A network is understood to mean the aggregate of all the channels.

The introduction of the casting compound into the mould, or more precisely the network, takes place in the fourth process step according to the invention. The introduction of the casting compound can in particular take place in at least three different ways. According to the invention, importance is attached in particular to the supply of the casting compound to the at least one inflow or to all the inflows. This takes place for example by means of at least one supply, comprising a line and an adapter, in particular with a seal, which is and/or are fastened to the sample holder and/or the substrate and of the mould by a form-fitting and/or friction-locked connection. The casting compound is transported into the network. for example by an excess pressure and/or by an evacuation of the network, in particular via the at least one outflow, and/or by capillary forces. It is also conceivable for the casting compound to be deposited by means of at least one deposition system with a needle in the vicinity of the at least one inflow. Capillary forces then transport the casting compound through the network.

The introduction of the casting compound by evacuation of the network of the mould takes place in a first preferred embodiment. The casting compound is introduced into the network in particular by generating an underpressure in the network. Generally, underpressure is always understood to mean a pressure that is less than the pressure of the casting compound. In particular, underpressure is understood to mean a pressure less than atmospheric pressure, in particular less than 1 bar. The network of the mould is evacuated via at least one outflow, while at the same time a supply of the casting compound takes place via at least one inflow. As a result of the evacuation of the network, a pressure difference arises between the external atmosphere and the interior of the network.

According to the invention, the excess pressure in relation to the network pushes the casting compound through the network. In a particularly preferred embodiment according to the invention, the generated vacuum ensures not only the transport of the casting compound into the network, but also the contact pressure which provides for the fixing of the mould on the substrate. The generated pressure in the network is less than 1 bar, preferably less than 10⁻¹ bar, still more preferably less than 5*10⁻² bar, most preferably less than 10⁻² bar, with utmost preference less than 10 bar.

The casting compound is introduced in particular by means of a supply, comprising a line and a seal, which directly adjoins the at least one inflow. A vacuum is preferably generated simultaneously in the network by means of a suction device, which adjoins the at least one outflow, for example via a further line and a further seal. Two particularly preferred effects according to the invention arise due to the generation of a vacuum. In the first place, a force F1 is exerted on the casting compound by the pressure difference between the exterior and the network, which force pushes the casting compound into the network. In the second place, this pressure difference generates an area force F2 and thus pushes the mould onto the substrate. Area force F2 ensures that the structured surfaces are in contact with the substrate at all points. A particularly optimum and preferred fixing of the mould on the substrate is thus brought about. In order that the mould does not rise from the substrate, pressure p1 of the casting compound must be less than or in the extreme case of identical magnitude to pressure p2 acting from the exterior. Furthermore, pressure p3 prevailing in the empty network through which the casting compound has not yet flowed must be less than pressure pi driving the casting compound forward and acting in the casting compound. Otherwise, a propagation of the casting compound through the network is not possible.

The effect of the capillary forces on the advance of the casting compound through the network is overlooked in this regard.

Pressure p1 lies between 10 bar and 10⁻⁶ mbar, preferably between 8 bar and 10⁻⁴ mbar, still more preferably between 6 bar and 10⁻² mbar, most preferably between 4 bar and 10⁻¹ bar, with utmost preference between 2 bar and 1 bar.

Pressure p2 lies between 10 bar and 10⁻⁶ mbar, preferably between 8 bar and 10⁻⁴ mbar, still more preferably between 6 bar and 10⁻² mbar, most preferably between 4 bar and 10 bar, with utmost preference between 2 bar and 1 bar.

Pressure p3 lies between 10 and 10⁻⁶ mbar, preferably between 8 bar and 10⁻⁴ mbar, still more preferably between 6 bar and 10 mbar, most preferably between 4 bar and 10⁻¹ bar, with utmost preference between 2 bar and 1 bar.

The introduction of the casting compound by the capillary effect takes place in the second preferred embodiment, wherein the casting compound is introduced by capillary forces into the network of the mould. The casting compound is advanced to the network via at least one inflow. As a result of the small size of the structures in the network, a casting compound front arises which is concave viewed against the propagation direction. This concave casting compound front leads to a reduction in the vapour pressure of the casting compound material ahead of the casting compound front. The pressure difference thus arising between the front and rear side of the casting compound drives the latter through the network.

The casting compound is introduced in particular by means of a supply, comprising a line. The supply is for example a tube, a needle and/or a nozzle. The supply in particular does not make contact either with the sample holder, the substrate or the mould, but rather deposits the casting compound in the vicinity of the at least one inflow. If there is a plurality of inflows, a corresponding number of supplies must be provided. The casting compound is drawn into the network exclusively by the capillary effect. A vacuum is however preferably generated in the network simultaneously by means of a suction device, which for example adjoins the at least one outflow via a line and a seal. As a result of the generation of a vacuum, two particularly preferred effects according to the invention arise. In the first place, a force F1 is exerted on the casting compound due to the pressure difference between the exterior and the network, which force pushes the casting compound into the network. In the second place, this pressure difference generates an area force F2 and thus pushes the mould onto the substrate. A particularly optimum and preferred fixing of the mould on the substrate is thus brought about.

The introduction of the casting compound by excess pressure takes place in a third preferred embodiment. The casting compound is pressed into the mould by a very high pressure. The embodiment according to the invention is therefore suitable in particular for hard moulds. In this case, not only a complete, but also a continuous contact of the structures of the mould with the substrate surface is guaranteed during the casting process. In this casting process, the casting compound is pressed into the network of the mould with a pressure greater than 1 bar, in particular more than 2 bar, more preferably more than 4 bar, most preferably more than 6 bar, with utmost preference more than 10 bar.

In particular, the casting compound is introduced by means of a supply, comprising a line and a seal, which directly adjoins the at least one inflow. A process chamber, in which the mould and the substrate are located, is preferably evacuated simultaneously by means of a suction device. A vacuum thus arises in the network. A force F1 is thus exerted on the casting compound by the pressure difference between the casting compound and the network, which force pushes the casting compound into the network.

A combination of the aforementioned casting processes or introduction methods is also conceivable.

The hardening of the casting compound takes place in the fifth process step according to the invention. The hardening takes place in particular either thermally and/all by means of electromagnetic radiation. The hardening takes place through the mould and/or via the sample holder or the substrate. The hardening preferably takes place, however, exclusively through the mould in order to be independent of the physical properties of the substrate. The hardening preferably takes place electromagnetically, since only a very small amount of heating, if any, and therefore a vanishingly small thermal expansion arises through exposure of the casting compound. In order to be able to harden the casting compound electromagnetically through the mould, the mould must have a corresponding transparency for the electromagnetic radiation used. Thermal hardening of the casting compound is also conceivable.

The removal of the mould from the casting compound takes place in the sixth process step according to the invention. The removal takes place by a relative movement between the mould and the substrate, wherein the mould and the substrate are moved apart from one another. In particular, the removal takes place by a movement, the direction of movement whereof is normal to the substrate surface. The removal is facilitated by the use a soft mould. The removal takes place in particular by a continuous and gradual withdrawal of the mould. The withdrawal is facilitated in particular by the use of a mould which is constituted as a soft stamp. The mould can thus be withdrawn gradually, in particular proceeding from a point of the periphery, and does not have to be withdrawn by a normal force, in particular a normal area load acting over the entire area.

In a further, particularly preferred embodiment, the removal of the mould can be facilitated by blowing a gas or gas mixture into the network. Gases can be blown into the network particularly preferably by using the inflows and/or outflows for the casting compound.

Further advantages, features and details of the invention emerge from the following description of preferred examples of embodiment and with the aid of the drawings. In the figures:

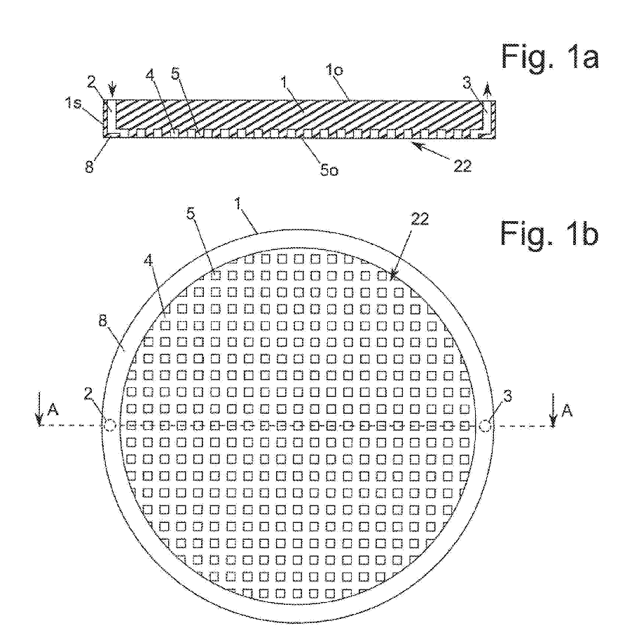

FIG. 1a shows a diagrammatic cross-sectional side view of a first embodiment of a mould according to the invention, not true to scale,

FIG. 1b shows a diagrammatic view of the first embodiment according to the invention from beneath, not true to scale,

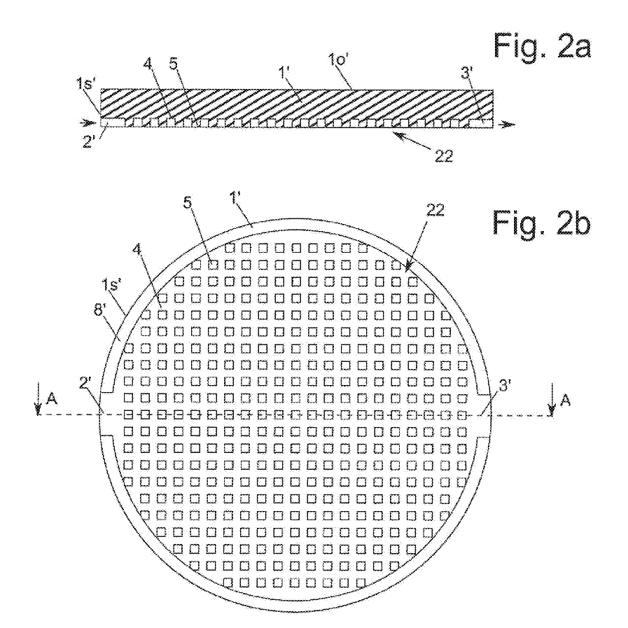

FIG. 2a shows a diagrammatic cross-sectional side view of a second embodiment according to the invention, not true to scale,

FIG. 2b shows a diagrammatic view of the second embodiment according to the invention from beneath, not true to scale,

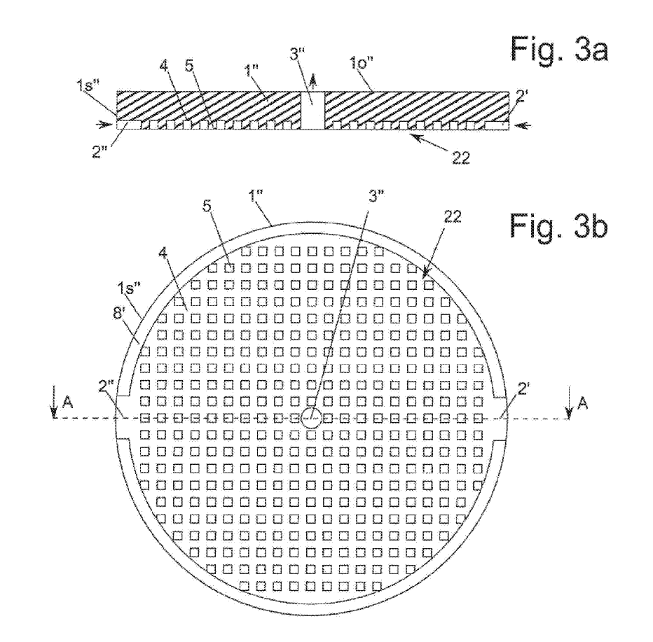

FIG. 3a shows a diagrammatic cross-sectional side view of a third embodiment according to the invention, not true to scale,

FIG. 3b shows a diagrammatic view of the third embodiment according to the invention from beneath, not true to scale,

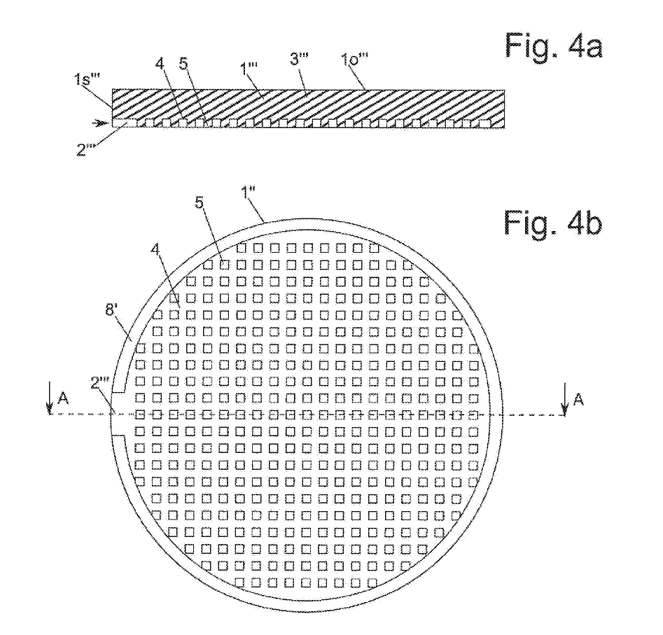

FIG. 4a shows a diagrammatic cross-sectional side view of a fourth embodiment according to the invention, not true to scale,

FIG. 4b shows a diagrammatic view of the fourth embodiment according to the invention from beneath, not true to scale,

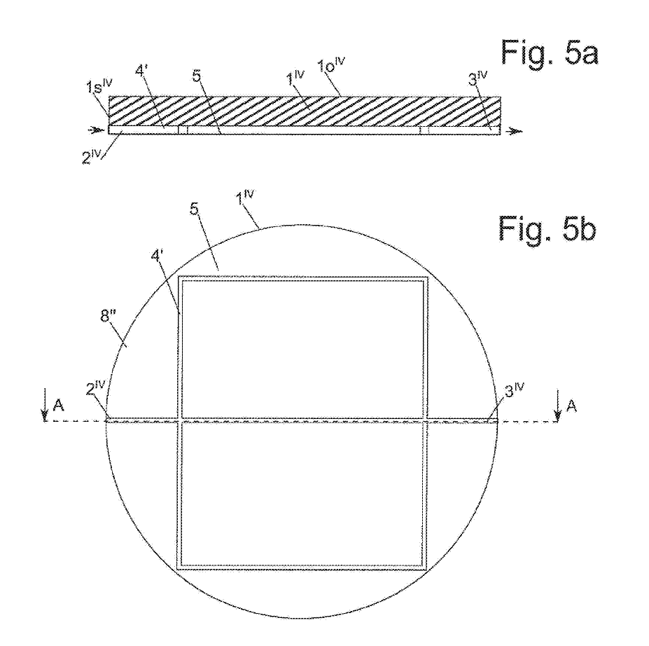

FIG. 5a shows a diagrammatic cross-sectional side view of a fifth embodiment according to the invention, not true to scale,

FIG. 5b shows a diagrammatic view of the fifth embodiment according to the invention from beneath, not true to scale,

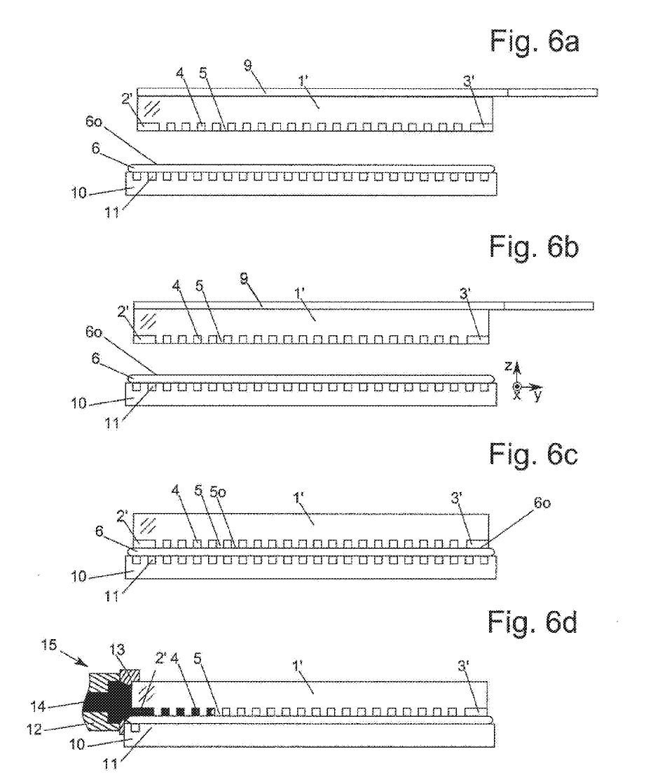

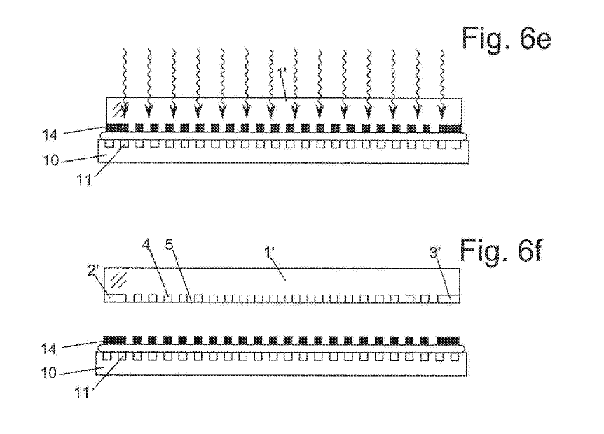

FIG. 6a shows a diagrammatic side view of a first process step according to the invention, not true to scale,

FIG. 6b shows a diagrammatic side view of a second process step according to the invention, not true to scale,

FIG. 6c shows a diagrammatic side view of a third process step according to the invention, not true to scale,

FIG. 6d shows a diagrammatic side view of a fourth process step according to the invention, not true to scale,

FIG. 6e shows a diagrammatic side view of a fifth process step according to the invention, not true to scale,

FIG. 6f shows a diagrammatic side view of a sixth process step according to the invention, not true to scale,

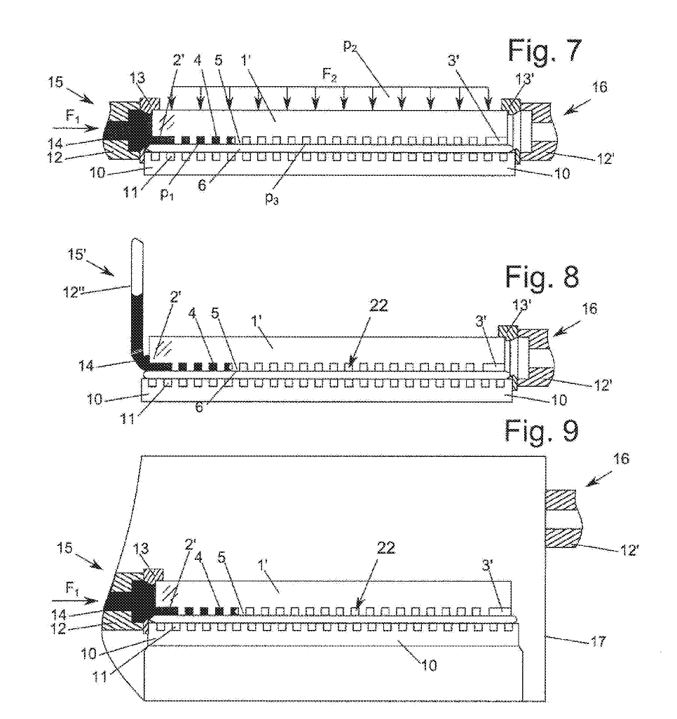

FIG. 7 shows a diagrammatic side view of a first embodiment of the casting according to the invention, not true to scale,

FIG. 8 shows a diagrammatic side view of a second embodiment of the casting according to the invention, not true to scale,

FIG. 9 shows a diagrammatic side view of a third embodiment of the casting according to the invention, not true to scale,

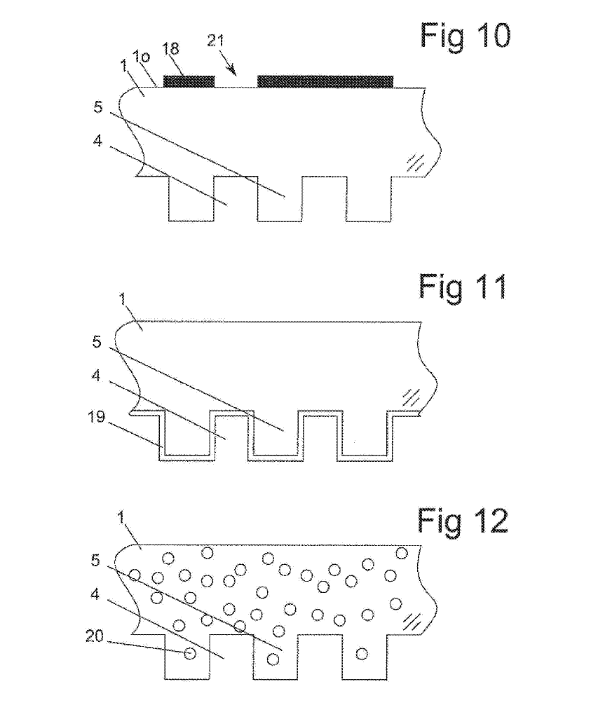

FIG. 10 shows a diagrammatic enlarged side view of a part of a sixth exemplary mould according to the invention, not true to scale,

FIG. 11 shows a diagrammatic enlarged side view of a part of a seventh exemplary mould according to the invention, not true to scale and

FIG. 12 shows a diagrammatic enlarged side view of a part of an eighth exemplary mould according to the invention, not true to scale.

Identical components or components with the same function are denoted by the same reference numbers in the figures.

FIG. 1a shows a lateral cross-sectional representation along intersecting line A-A (see FIG. 1b) of a first mould 1 according to the invention with an inflow 2 and an outflow 3, which are connected to one another via a network 22, comprising a plurality of channels 4. A network 22 is understood to mean the aggregate of all channels 4 in mould 1. Mould 1 comprises an edge 8. Inflow 2 and outflow 3 leave mould 1 via upper mould surface 1o. Possible adapters, which are connected to inflow 2 and/or outflow 3, have not been shown for the sake of clearer illustration. Moreover, mould 1 comprises structures 5 on its structured surface 5o. Structures 5 are elevations, structural surfaces 5o whereof make contact with the substrate.

FIG. 1b shows a view of first mould 1 according to the invention from beneath.

FIG. 2a shows a lateral cross-sectional representation of a second mould 1′ according to the invention with an edge 8′ as well as an inflow 2′ and an outflow 3′, which are connected to one another via a network 22. Inflow 2′ and outflow 3′ leave mould 1′ via lateral mould face 1s′. Possible adapters, which are connected to inflow 2′ and/or outflow 3′, have not been shown for the sake of clearer illustration. Moreover, reference is made to the embodiments in respect of FIG. 1a and FIG. 1b.

FIG. 2b shows a view of second mould 1′ according to the invention from beneath.

FIG. 3a shows a lateral cross-sectional representation of a third mould 1″ according to the invention with two symmetrically positioned inflows 2″ and an outflow 3″, which are connected to one another via a network 22. Inflows 2″ leave mould 1″ via lateral mould face 1s″. Outflow 3″ leaves mould 1″ via mould surface 1o″. Possible adapters, which are connected to inflows 2 and/or outflow 3″, have not been shown for the sake of clearer illustration. Moreover, reference is made to the embodiments in respect of FIG. 1a and FIG. 1b.

FIG. 3b shows a view of third mould 1″ according to the invention from beneath.

FIG. 4a shows a lateral cross-sectional representation of a fourth mould 1′″ according to the invention with inflow 2′. The embodiment according to the invention does not comprise an outflow. Mould 1′″ is preferably porous, so that gases can escape via mould 1′″. Outflow 3′″ is therefore identical to porous mould 1′″. Moreover, reference is made to the embodiments in respect of FIG. 1a and FIG. 1b.

FIG. 4b shows a view of fourth mould 1′″ according to the invention from beneath.

FIG. 5a shows a lateral cross-sectional representation of a fifth mould 1^{IV} according to the invention, in particular a special variant of the second embodiment according to the invention, wherein network 22 comprises few, in particular branching, channels 4′. Mould 1^{IV} comprises an edge 8″. Moreover, reference is made to the embodiments in respect of FIG. 1a and FIG. 1b and respectively FIG. 2a and FIG. 2b.

FIG. 5b shows a view of mould 1^{IV} from beneath.

FIG. 6a shows a first process step according to the invention, wherein a robot 9 loads a, in particular transparent (indicated with three strokes), mould 1′ according to the invention over a substrate 6. Substrate 6 is fixed on a sample holder 10 by means of fixings 11, in particular vacuum tracks.

In FIG. 6b, a second process step according to the invention is represented, wherein mould 1′ according to the invention is aligned relative to substrate 6. The alignment takes place in the x- and/or y-direction. Mould 1′ is preferably still located on robot 9. Fixing of mould 1′ by robot 9 on a second, upper sample holder (not represented), which sample holder has a better resolution accuracy, is also conceivable. In particular, the loading of mould 1′ in an alignment system is conceivable in order to carry out the alignment with a high degree of precision.

FIG. 6c shows a third process step according to the invention, wherein the contacting of structured surface So with substrate surface 6o takes place. Structured surface 5o can in particular be coated, in order to facilitate mould removal in a subsequent process step. An interconnecting and open network 22 arises as a result of the contacting of structured surface 5o with substrate surface 6o. Network 22 represents the aggregate of all channels 4. Interconnecting means that the channels are connected to one another. Open means that there is at least one access to the network, and therefore to a least one of the channels.

FIG. 6d represents a fourth process step according to the invention, the introduction of casting compound 14 into network 22. The introduction of casting compound 14 can take place in several different ways.

According to the invention, the supply of casting compound 14 to all inflows 2′ is of particular importance. FIG. 6d, this takes place for example by means of a supply 15, comprising a line 12 and a seal 13, which is or are fastened to sample holder 10 and/or substrate 6 and mould by a form-fitting and/or friction-locked connection. Casting compound 14 is transported into network 22 either by an excess pressure and/or by an evacuation of network 22, in particular via outflow 3′, and/or by capillary forces. It is also conceivable for casting compound 14 to be deposited by means of a deposition system with a needle in the vicinity of inflows 2′, Capillary forces then transport casting compound 14 through network 22.

FIG. 6e shows a fifth process step according to the invention, wherein casting compound 14 is hardened. The hardening takes place through mould 1′ and/or through sample holder 10 or substrate 6. The hardening preferably takes place, however, exclusively through mould 1′ in order to be independent of the physical properties of substrate 10. The hardening preferably takes place electromagnetically, since only a very small amount of heating, if any, and therefore a vanishingly small thermal expansion arises through exposure of casting compound 14. In order to be able to harden casting compound 14 electromagnetically through mould 1′, mould 1′ must have a corresponding transparency for the electromagnetic radiation used. Thermal hardening of the casting compound 14 is also conceivable. The arrows represented in FIG. 6e stand symbolically for the electromagnetic radiation and/or the amount of heat.

In a final, sixth process step according to FIG. 6t, the removal of mould 1′ from casting compound 14 takes place. The removal is represented in FIG. 6f by the raising of mould 1′. A gradual withdrawal of mould 1′, in particular starting from the edge of mould 1′ or of substrate 6, is however also conceivable, if mould 1′ is a soft mould. The height of the generated casting compound structures from casting compound 14 on substrate surface 6o corresponds to the height of channels 4.

FIG. 7 shows a first embodiment according to the invention for filling network 22 in the optimum manner with a casting compound 14. Casting compound 14 is introduced by means of a supply 15, comprising a line 12 and a seal 13, which directly adjoins inflows 2′. A vacuum is preferably generated simultaneously in network 22 by means of a suction device 16, which adjoins outflow 3′, for example via a further line 12′ and a further seal 13′. Two particularly preferred effects according to the invention arise due to the generation of a vacuum. In the first place, a force 1 is exerted on casting compound 14 due to the pressure difference between the exterior and the network, which force pushes casting compound 14 into network 22. In the second place, this pressure difference generates an area force F2 and thus pushes mould 1′ onto substrate 6. A particularly optimum and preferred fixing of mould 1′ on substrate 6 is thus brought about. In order that mould 1′ does not rise from substrate 6, pressure p1 in casting compound 14 must be less than or in the extreme case of equal magnitude to pressure p2 acting from the exterior. Furthermore, pressure p3 prevailing in network 22 must be less than pressure p1 acting in casting compound 14. Otherwise, a propagation of casting compound 14 through network 22 is not possible. The effect of the capillary forces on the advance of casting compound 14 through network 22 is overlooked in this regard. Pressure p2 is 1.1 times, preferably 1.2 times, still more preferably 1.3 times, most preferably 1.4 times, with utmost preference 1.5 times as great as pressure p1. Pressure p1 is 1.1 times, preferably 1.2 times, still more preferably 1.3 times, most preferably 1.4 times, with utmost preference 1.5 times as great as pressure p3.

FIG. 8 shows a second embodiment according to the invention for filling network 22 in the optimum manner with a casting compound 14. Casting compound 14 is introduced by means of a supply 15′, comprising a line 12″. Supply 15′ is for example a tube, a needle or a nozzle. Supply 15′ does not make contact either with sample holder 10, substrate 6 or mould 1′, but rather deposits casting compound 14 in the vicinity of inflow 2′. If there is a plurality of inflows, a corresponding number of supplies 15′ must be provided. Casting compound 14 is preferably drawn into network 22 exclusively by the capillary effect. Still more preferably, however, a vacuum is generated in network 22 simultaneously by means of suction device 16, which for example adjoins outflow 3′ via line 12′ and seal 13′. As a result of the generation of a vacuum, two particularly preferred effects according to the invention arise. In the first place, as in FIG. 7, a force F1 is exerted on casting compound 14 due to the pressure difference between the exterior and network 22, which force pushes casting compound 14 into network 22. In the second place, this pressure difference generates an area force F2 and thus pushes mould 1′ onto substrate 6. A particularly optimum and preferred fixing of mould 1′ on substrate 6 is thus brought about.

FIG. 9 shows a third embodiment according to the invention for filling network 22 in the optimum manner with a casting compound 14. Casting compound 14 is introduced by means of a supply 15′, comprising a line 12 and a seal 13, which directly adjoins inflows 2′. A process chamber 17, in which mould 1′ and substrate 10 are located, is preferably evacuated simultaneously by means of a suction device 16. A vacuum thus arises in network 22. A force F1 is thus exerted on casting compound 14 due to the pressure difference between casting compound 14 and network 22, which force pushes casting compound 14 into network 22.

FIG. 10 shows a diagrammatic, enlarged partial detail of a further mould 1 according to the invention, on mould surface to whereof mask 18 has been deposited. Mask 18 is in particular opaque for the wavelengths of the wavelength region of the radiation with the aid of which the casting compound is hardened. By using a mask 18, those regions of the casting compound that are to be hardened can be precisely determined. In particular embodiments according to the invention, apertures 21 do not necessarily have to be congruent with network 22. A finer structuring of network 22 is thus permitted, since those regions of network 22 that are not hardened by the electromagnetic radiation can be removed from substrate surface 6o in subsequent process steps. In FIG. 10, this situation is represented by way of example by the fact that mask 18 on the right-hand side of the drawing covers a part of network 22, so that no aperture 21 is formed above this part of the network. Masks 18, apertures 21 whereof are congruent with network 22 are of course also conceivable. Apertures 21 are incorporated in mould 1 in a much preferred embodiment.

FIG. 11 shows a further embodiment according to the invention of a mould 1 with a coating 19 of structures 5. Coating 19 is preferably an anti-adhesion coating, which permits easy detachment of mould 1, more precisely of structures 5, from substrate 6 and/or embossing compound 14. Moreover, reference is made to the embodiments of FIG. 10.

FIG. 12 shows a further embodiment according to the invention of mould 1. Mould 1 has an open porosity with pores 20, which permit enclosed gases to be carried away via mould 1. Moreover, reference is made to the embodiments of FIG. 10.

### LIST OF REFERENCE NUMBERS

1, 1′, 1″, 1′″, 1^{IV mould}

1o, 1o′, 1o′″, 1o^{IV} mould surface

1s, 1s′, 1s″, 1s′″, 1s^{IV} lateral mould face

2, 2′, 2″, 2′″, 2^{IV} inflow

3, 3′, 3″, 3′″, 3^{IV} outflow

4, 4′ channel

5 structure

5o structured surface

6 substrate

6o substrate surface

7, 7′, 7″, 7′″ stack

8, 8′, 8″ edge

9 robot

10 sample holder

11 fixings

12, 12′, 12″ line

13, 13′ seal

14 casting compound

15, 15′ supply

16 suction device

17 process chamber

18 mask

19 coating

20 pores

21 aperture

22 network

p1, p2, p3 pressures

F1 force

F2 area force

1-15. (canceled)

16. A method for producing millimetre and/or micrometre and/or nanometre-size structures on a substrate surface of a substrate, the method comprising:
a) arranging a mould over the substrate surface, said mould having a structured surface and a network comprised of a plurality of channels;
b) mechanically and/or optically aligning the mould relative to the substrate surface by means of alignment marks;
c) contacting the structured surface of the mould with the substrate surface of the substrate;
d) introducing a casting compound into the network of the mould for the distribution of the casting compound over the structured surface of the mould;
e) hardening the casting compound to produce the structures on the substrate surface of the substrate; and
removing the mould from the casting compound.

17. The method according to claim 16, wherein the structures on the substrate surface are produced free from a residual layer.

18. The method according to claim 16, wherein the casting compound is introduced. by capillary forces into the network of the mould.

19. The method according to claim 16, wherein the casting compound is introduced into the network by generating an underpressure in the network, wherein the pressure in the network is less than 1 bar.

20. The method according to claim 16, wherein the casting compound is introduced into the network of the mould by a pressure (p1) between 10 bar and 10⁻⁶ mbar.

21. The method according to claim 16, wherein the casting compound has a low viscosity, wherein the viscosity at room temperature lies between 10E6 mPa*s and 1 mPa*s.

22. The method according to claim 16, wherein the mould is located in a process chamber capable of being evacuated and the method is carried out in a vacuum atmosphere with a pressure less than 0.1 bar.

23. A mould for producing millimeter and/or micrometer and/or nanometer-size structures on a substrate surface, the mould comprising:
a structured surface;
a mould surface that lies opposite the structured surface;
at least one inflow for receiving a casting compound; and
a network comprised of a plurality of channels, said network connected to the at least one inflow for distributing the casting compound over the structured surface,
wherein a mask with apertures is arranged on the mould surface.
